(19) United States
(12) Patent Application Publication
(10) Pub. No.: US 2009/0039660 A1
(43) Pub. Date: Feb. 12, 2009

(54) MULTI-PURPOSE WEDGE FOR EMERGENCY WORKERS

(76) Inventor: Joseph Gonzalez, Waldwick, NJ (US)

Correspondence Address: EDWARDS ANGELL PALMER & DODGE LLP, P.O. BOX 55874, BOSTON, MA, 02205, US

(21) Appl. No.: 11/836,885

(22) Filed: Aug. 10, 2007

(51) Int. Cl. E05C 17/54; C09K 21/00; E05C 17/02

(52) U.S. Cl. 292/342; 16/82; 252/607

(57) ABSTRACT

A multi-purpose wedge, with a body having two generally opposed tapering surfaces that meet at a real or imaginary edge, a core made from a first fire resistant material, a coating of a second fire resistant material, and an optional layer of photoluminescent material disposed over at least a portion of the coating of second fire resistant material is provided.

### BACKGROUND OF THE MENTION

1. Field of the Invention

The present invention relates to a multi-purpose wedge for emergency workers such as firefighters. More particularly, the present invention is directed to a wedge that may be both photoluminescent and highly fire resistant.

2. Description of Related Art

Firefighters often need to prop open doors in a home or building during the process of extinguishing a structure fire and clearing the home or building during the fire. Generally, door wedges have been used for years by firefighters for this purpose. Generally, such door wedges are made of an impressionable or malleable material which conforms slightly under pressure. For example, soft wood, such as pine is typically used to make such door wedges. Such pine wedges are typically positioned between the floor and the bottom of a door, conforming as they are press-fitted into place. This press-fit allows for an effective frictional engagement to be created which securely prevents a door from closing.

Although effective in propping doors open, there are problems using wedges made from a material such as pine. Typical emergency situations such as fires require use of materials that can sustain extreme environmental conditions, such as heat, flame and water. Pine wood door wedges lack water resistance and are not heat or flame resistant. As can be appreciated, this can present serious safety issues in the case of a fire, and may potentially result in a catastrophic incident that could result in death.

Because of this lack of durability, many manufacturers of door wedges have attempted to design wedges using various other materials that replicate the effectiveness of a soft wood, such as pine. For example, some door wedges are manufactured using synthetic materials such as plastic, rubber, or foam. Although some of these materials may provide better weather resistance, many of these wedges still generally cannot endure the thermal conditions encountered in firefighting. When these materials are modified to meet the thermal requirements, many become rigid and lose their malleable conforming characteristics.

In addition, low visibility due to smoke and lack of lighting is another serious problem confronted by firefighters. Conventional wedge devices have included visually prominent colors or reflective surfaces, but again, are not satisfactory for use in a high-temperature environment.

As can be seen, there is a significant need in the art for an improved door wedge that maintains conformability but is still durable in extreme environments. Moreover, there is a continued need in the art for a door wedge that is highly visible in conditions of low visibility. The present invention provides a solution for these problems.

### SUMMARY OF THE INVENTION

Advantages of the present invention will be set forth in and become apparent from the description that follows. Additional advantages of the invention will be realized and attained by the methods and systems particularly pointed out in the written description and claims hereof, as well as from the appended drawings.

To achieve these and other advantages and in accordance with the purpose of the invention, as embodied herein, the invention includes a multi-purpose wedge, with a body having two generally opposed tapering surfaces that meet at a real or imaginary edge, a core made from a first fire resistant material, a coating of a second fire resistant material, and a layer of photoluminescent material disposed over at least a portion of the coating of second fire resistant material. The multi-purpose wedge includes a body having two generally opposed tapering surfaces that meet at a real or imaginary edge.

The invention also includes a method for making a multi-purpose wedge, including the steps of providing a wedge shaped core made from a first fire resistant material, applying a coating of a second fire resistant material to the core; and applying a layer of photoluminescent material over at least a portion of the coating of second fire resistant material.

It is to be understood that the foregoing general description and the following detailed description are exemplary and are intended to provide further explanation of the invention claimed.

The accompanying drawings, which are incorporated in and constitute part of this specification, are included to illustrate and provide a further understanding of the method and system of the invention. Together with the description, the drawings serve to explain principles of the invention.

### BRIEF DESCRIPTION OF THE DRAWINGS

FIG. 1 is a perspective view of an exemplary embodiment of a multi-purpose wedge in accordance with the present invention.

FIG. 2 is an side view of the wedge of FIG. 1.

FIG. 3 is a cross-section of the wedge of FIG. 1, taken along line 3-3 of FIG. 2.

FIG. 4 illustrates a kit of multi-purpose wedges in accordance with the present invention.

FIGS. 5 and 5(A) illustrate uses of a multi-purpose wedge made in accordance with the present invention.

FIG. 6 illustrates further use of a multi-purpose wedge made in accordance with the present invention to hold a door open.

FIGS. 7(A)-7(B) illustrate use of a multi-purpose wedge made in accordance with the present invention to turn off an overhead sprinkler.

### DETAILED DESCRIPTION OF PREFERRED EMBODIMENTS

Reference will now be made in detail to the present preferred embodiments of the multi-purpose wedge, examples of which are illustrated in the accompanying drawings. The method and corresponding steps of the invention will be described in conjunction with a detailed description of the invention.

The multi-purpose wedge described herein may be used for propping open a door or for stopping the flow of water from an overhead sprinkler. The multi-purpose wedge is particularly suited for propping open doors during rescue operations and other tasks performed by firefighters. The wedge may be inserted between the bottom of the door and the floor, between the door and the doorjamb, near the hinges of the door, or in any other location. In addition, the photoluminescence of the wedge make it ideal for marking a room, for example, to indicate the room has been searched by rescue personnel, or for marking an exit path in a smoke-filled building.

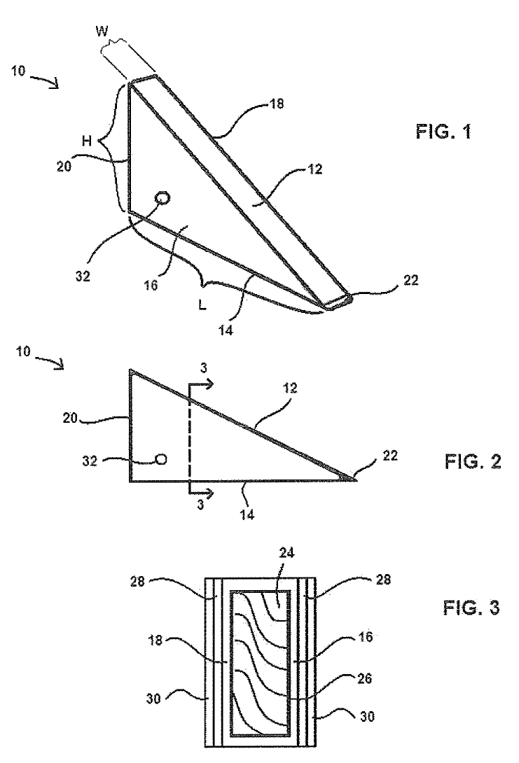

For purpose of explanation and illustration, and not limitation, an exemplary embodiment of the multi-purpose wedge in accordance with the present invention is shown in FIGS. 1 and 2 and is designated generally by reference numeral 10. Wedge 10 has a right triangular cross section. However, the present disclosure also contemplates using a wedge having any triangular cross section, as well as any trapezoidal cross section. Other cross sections may also be used without departing from the scope of the present invention, Wedge 10 includes a first tapering surface 12 and a second tapering surface 14. Tapering surfaces 12, 14, lie generally in intersecting planes, thus forming a real or imaginary edge where the respective planes meet. Wedge 10 also includes additional surfaces, or facets 16, 18, which generally lie in parallel planes and form the sides of wedge 10. Wedge 10 also includes a rear surface 20, which generally lies in a plane that forms a right angle with respect to tapering surface 14.

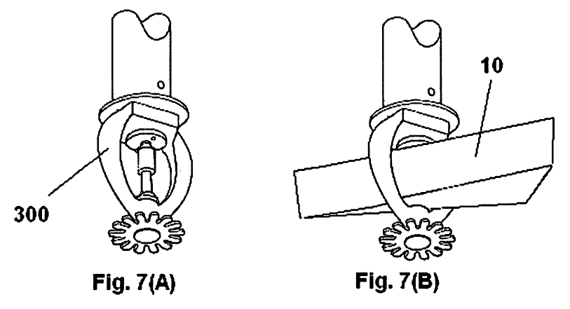

In the embodiment shown in FIG. 1, tapering surfaces 12 and 14 meet at tip 22. Tip 22 is adapted and configured to fit into and shut off an overhead sprinkler such as that illustrated in FIG. 7(A). For example, as depicted in FIG. 7(B), tip 22 of wedge 10 can be inserted into a port of an overhead sprinkler to stop the flow of water.

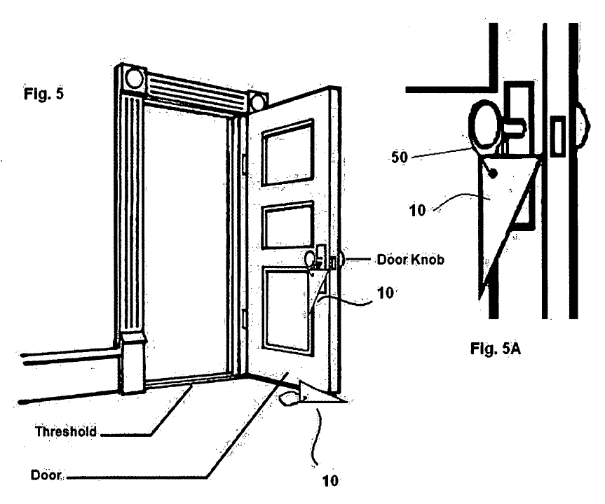

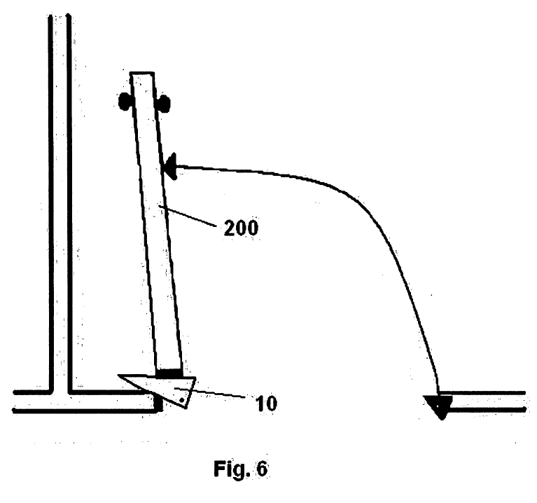

Wedge devices made in accordance with the invention can have any suitable dimension. In accordance with a preferred embodiment and as illustrated in FIG. 1, device 10 preferably has a length L between about five and ten inches, more preferably between about six and eight inches, and most preferably about six and one half inches. Device 10 preferably has a height H between about one and a half and four inches, more preferably between about two and three inches, and most preferably about two and one half inches. Device 10 preferably has a width W between about one half of an inch and one and one half inches, more preferably between about one half of an inch and one inch, and most preferably about three quarters of an inch. Actual experimentation has shown that, in practice, having a wedge 10 that is about six and a half inches in length, about two and a half inches in height and about three quarters of an inch in thickness is particularly suitable for a variety of reasons. First, this particular combination of dimensions provides for a gentle taper that is suitable for shutting off an overhead sprinkler when inserted therein (see FIGS. 7(A)-7(B)). Moreover, the width of three quarters of an inch is also useful in this regard. In addition, having a substantial height of about two and one half inches or greater, for example, can be useful for propping a door open on an uneven surface or a stoop, whereas much smaller wedges (e.g., one inch in height) are not as useful. Typical orientations of wedge 10 in use are depicted in FIG. 5, wherein wedge 10 is used as a target exit device by suspending it from a doorknob and to jam the door open. In FIG. 6, door wedge 10 is depicted holding a door open by inserting it into the hinge gap formed between the door and the jamb.

FIG. 3 is a cross section of wedge 10 taken along line 3-3. Wedge 10 includes a core 24 made from a first fire resistant material. In one exemplary embodiment, core 24 comprises pressure-impregnated, fire-retardant treated wood. The wood may be treated, for example, with a substance including an amide, an oxy-acid of phosphorous, an oxyacid of boron, a metal salt of boron, and sodium hydroxide. Examples of suitable treatments to produce a core 24 of fire resistant material are disclosed in U.S. Pat. No. 5,151,225, the entire contents of which are incorporated herein by reference. Such treated wood is commercially available, for example, from Hoover Treated Wood Products, Inc. (Thomson, Ga., USA). Using a conformable material such as wood (e.g., pine) that has been suitably treated to be thermally resistant maintains the benefits of using a soft wood, without the drawbacks typically accompanying wood. This results in a door wedge that is relatively inexpensive, yet effective.

Wedge 10 also includes a coating 26 of a second fire resistant material disposed on the core. Coating 26 may include a fire retardant composition including, for example, an ammonium phosphate substance, which is in contact with a carbonific, and a nitrogenous spumific. A polysaccharide and/or a nonionic alkylpolyglycoside surfactant may also be present. Coating 26 covers substantially all of the surface area of wedge 10, including the tapering surfaces, the facets, and the rear surface. Suitable coating materials may be obtained commercially from Capital Structures (Springdale, Ark., USA (or No-Burn, Inc., Wadsworth, Ohio, USA)) under the trade name of NO-BURN®. In particular, it has been found that NO-BURN® Plus (RETAIL), a composition that is applied similarly to latex based paint, is preferred. Preferably, one coating 26 may be used. Alternatively, if desired, additional coatings of similar or different fire retardant materials may be used, as described herein. Preferably, coating 26 is applied over the entire surface of device 10.

A variety of additional/alternative compositions may be used for the second fire resistant material and/or additional fire retardant coatings, if desired, including, for example those described in U.S. Pat. Nos. 6,982,049, 6,989,113, 5,989,706, 5,925,457, 5,645,926, 5,603,990, 5,064,710, 4,635,025, 4,345,002, 4,339,357, 4,265,791, 4,241,145, 4,226,907, 4,221,837, 4,210,452, 4,205,022, 4,201,677, 4,201,593, 4,137,849, 4,028,333, 3,955,987 and 3,934,066 and U.S. Patent Publication Nos. 2006/0167131 and 2006/0189232, 2005/0022466, 2005/138888. Each of these documents is incorporated by reference herein in its entirety. As will be appreciated, this second fire resistant material acts as a further thermal safeguard, yet does not compromise the conforming character of the door wedge itself, that permits the door wedge to conform to various surfaces against which it is urged.

Wedge 10 may also include a layer 28 of photoluminescent material disposed over at least a portion of the coating 26 of the second fire resistant material. Photoluminescent material is defined as a material capable of storing light energy from a light source and then emitting light energy for a prolonged period of time after the light source has been removed. In one exemplary embodiment, layer 28 includes an alkaline earth metal aluminate as a main component, such as strontium aluminate. Suitable coating materials for layer 28 may be obtained commercially from EZ-Bright Corporation or from Co-leash Corporation (Tampa, Fla., USA) under the trade name of KryptaGlow™. Additional examples of photoluminescent materials that may be used as part of layer 28 are disclosed in U.S. Patent Application Publication No. 2006/0001007, the entire contents of which are incorporated by referenced herein. In one preferred embodiment, layer 28 includes a strontium aluminate based photoluminescent material. Coating 28 may be applied over the entirety of the surface of device 10, or over a portion thereof. For example, if desired, coating 28 may be applied only to facets 16, 18, as these surfaces are the most conspicuous and visible in the dark.

When the coating 28 has been suitably charged by incident light (e.g, ultraviolet light) and begins to emit light, generally in the blue-green region of the visible spectrum, device 10 will become highly visible to an observer. Emitting light in the blue-green portion of the spectrum is highly advantageous, as it is a higher energy wavelength that is more likely to be visible in a smoky condition, and because the human eye is particularly sensitive to these wavelengths in dark, smoky conditions, typical of the interior of a burning building.

Accordingly, by providing such a coating 28, the door wedge is conspicuous and visible in low visibility conditions. Such conditions are typical of those encountered by the firefighter. Accordingly, embodiments of the invention are made from a conforming material that is thermally resistant, yet conspicuous. As will be appreciated by those of skill in the art, this is particularly advantageous.

Wedge 10 may further include a light transmissive coating 30 disposed over at least a portion of photoluminescent layer 28. Light transmissive coating 30 provides protection for layer 28. Coating 30 may be made, for example, from a lacquer based material, or alternatively an epoxy based coating, as desired. It will be noted that coating 30 is primarily present to protect coating 28 from damage to preserve the luminescent properties of device 10 by preventing the removal of coating 28. Suitable light transmissive heat resistant materials may also be used for coating 30, as desired.

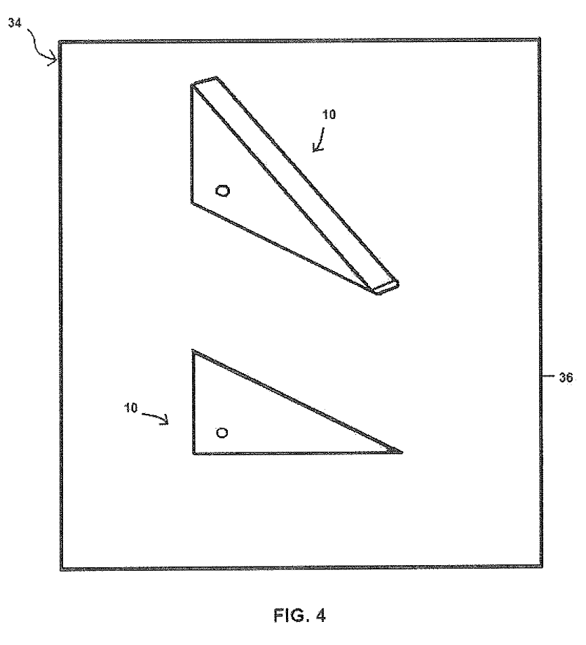

In one preferred embodiment, wedge 10 includes a through hole 32. A lanyard 50 or other suitable retaining device can be inserted through hole 32 to allow a firefighter to easily attach the wedge to a belt or helmet. Additionally, the lanyard 50 can be used to hang wedge 10 on a doorknob or other object to mark a room or an exit path as depicted in FIG. 5(A) so that wedge 10 can be used as a target exit device, particularly if it is adapted to glow in the dark as described herein. Wedge 10 may also be included in a kit 34 as depicted in FIG. 4. Kit 34 includes a plurality of wedges 10 that may be disposed in a packaging 36 such as a box, a bag, shrink wrap, or the like. Wedges 10 included in kit 34 may be of varying shapes and sizes or the same size, as desired. Lanyard 50 is preferably made from a fire resistant material such as one including aramid fibers. Suitable commercially available materials include materials sold under the trade names of NOMEX® and KEVLAR®.

A method for making a multi-purpose wedge is also provided. The method includes providing a wedge-shaped core made from a first fire resistant material, applying a coating of a second fire resistant material to the core, and applying a layer of photoluminescent material over at least a portion of the coating of second fire resistant material. A light transmissive protective coating may also be applied to at least a portion of the photoluminescent layer. Suitable materials for practicing this method are described herein above.

The methods and systems of the present invention, as described above and shown in the drawings, provide for a multi-purpose wedge with superior properties including fire resistance and photoluminescence. It will be apparent to those skilled in the art that various modifications and variations can be made in the device and method of the present invention without departing from the scope of the invention as outlined in the appended claims and their equivalents.

1. A multi-purpose wedge, comprising a body having two generally opposed tapering surfaces that meet at a real or imaginary edge, the body including:
a) a core made from a first fire resistant conformable material;
b) a coating of a second fire resistant material disposed on the core; and
c) a layer of photoluminescent material disposed over at least a portion of the coating of second fire resistant material.

2. The multi-purpose wedge of claim 1, further comprising a light transmissive coating disposed over at least a portion of the layer of photoluminescent material.

3. The multi-purpose wedge of claim 1, wherein:
a) the multi-purpose wedge further includes at least one facet substantially defined between the two generally opposed tapering faces, and
b) the layer of photoluminescent material is disposed substantially on the at least one facet.

4. The multi-purpose wedge of claim 1, wherein the first fire resistant material includes chemically treated wood.

5. The multi-purpose wedge of claim 1, wherein the second fire resistant material includes an ammonium phosphate salt in combination with an active hydrogen-containing nitrogenous organic compound spumific.

6. The multi-purpose wedge of claim 1, wherein the layer of photo luminescent material includes strontium aluminate based photoluminescent material.

7. The multi-purpose wedge of claim 1, wherein the wedge has a tip that is adapted and configured to fit into and shut off an overhead sprinkler.

8. The multi-purpose wedge of claim 1, wherein the wedge has a length between about five and ten inches, a height between about one and one half and four inches, and a width between about one half of an inch and one and one half inches.

9. The multi-purpose wedge of claim 1, wherein the wedge has a length between about six and eight inches, a height between about two and three inches, and a width between about one half of an inch and one inch.

10. The multi-purpose wedge of claim 1, wherein the wedge has a length of about six and one half inches, a height of about two and one half inches, and a width of about three quarters of an inch.

11. The multi-purpose wedge of claim 1, further comprising a loop of flexible material attached to the wedge to facilitate hanging the wedge from an object.

12. A kit comprising a plurality of multi-purpose wedges as recited in claim 1.

13. The kit of claim 12, wherein at least two of the wedges in the kit are of different sizes.

14. The kit of claim 12, wherein at least two of the wedges in the kit are of the same size.

15. A method for making a multi-purpose wedge, comprising:
a) providing a wedge shaped core made from a first fire resistant material, the core having two generally opposed tapering surfaces that meet at a real or imaginary edge;
b) applying a coating of a second fire resistant material to the core; and
c) applying a layer of photoluminescent material over at least a portion of the coating of second fire resistant material.

16. The method of claim 15, further comprising applying a light transmissive coating disposed over at least a portion of the layer of photoluminescent material.

17. The method of claim 15, wherein:
a) the core further includes at least one facet substantially defined between the two generally opposed tapering faces, and
b) the layer of photoluminescent material is disposed substantially on the at least one facet.

18. The method of claim 15, wherein the first fire resistant material includes chemically treated wood.

19. The method of claim 15, wherein the second fire resistant material includes an ammonium phosphate salt in combination with an active hydrogen-containing nitrogenous organic compound spumific.

20. The method of claim 15, wherein the layer of photo luminescent material includes strontium aluminate based photoluminescent material.
